(19) United States
(12) Patent Application Publication
(10) Pub. No.: US 2024/0297961 A1
(43) Pub. Date: Sep. 5, 2024

(54) Edge Assisted Virtual Calling

(71) Applicant: Meta Platforms Technologies, LLC, Menlo Park, CA (US)

(72) Inventors: Pranav SAXENA, Sunnyvale, CA (US); Shreya JAIN, San Jose, CA (US); Amogh GUPTE, Middletown, DE (US)

(21) Appl. No.: 18/402,136

(22) Filed: Jan. 2, 2024

Related U.S. Application Data
(60) Provisional application No. 63/487,626, filed on Mar. 1, 2023.

(51) Int. Cl. H04N 7/15; G02B 27/01

(52) U.S. Cl. CPC H04N 7/157; G02B 27/017

(57) ABSTRACT

Implementations augment images with depth information to support hologram display. An edge system can receive, from a source system, images of a user. For example, the images can be two-dimensional images captured by multiple cameras at different perspectives (e.g., stereoscopic images), or single perspective images. The edge system can estimate depth information using the images, for example by processing the images using an engine and one or more machine learning models, and generate depth encoded images. The edge system can then transmit the depth encoded images to a target system, which can ultimately display a hologram of the user using the depth encoded images. Accordingly, implementations can offload, from end-user devices (e.g., the source system and/or target system), hologram workloads to an edge system loaded with an engine and machine learning model(s).

### CROSS-REFERENCE TO RELATED APPLICATIONS

This application claims priority to U.S. Patent Provisional Application No. 63/487,626 filed on Mar. 1, 2023 and titled “Edge Assisted Virtual Calling,” and which is herein incorporated by reference in its entirety.

### TECHNICAL FIELD

The present disclosure is directed to edge assisted virtual calling with visual user presence.

### BACKGROUND

As the global marketplace increases and challenges such as distributed teams become more prevalent, remote working, collaboration, and social connectivity across large geographic regions is becoming ever more common. Remote working typically involves an assortment of technologies such as remote access to shared documents, various texts-based communication services (e.g., email, instant message, text message, etc.), telephone communication, and video calling. Such remote working provides a number of benefits, such as reduced travel times, increased health and safety, and greater flexibility. However, remote workers face various challenges not experienced by their in-office counterparts, such as physical isolation, limited social connectivity, and other challenges related to remote work. Collaboration tools that provide a visual user presence, such as video or holographic calling, can mitigate these challenges. Video or holographic calling can similarly provide a level of social connectivity to users that are physically separate, such as separated by large distances that make physical colocation impractical. However, traditionally these collaboration tools can place heavy computing burdens on client devices and can be impractical for certain client devices with limited computing resources.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a system diagram illustrating components for edge assisted virtual calling from a source system to a target system.

FIG. 6 is a diagram of an edge assisted workflow for processing visual frames during an edge assisted virtual call.

FIG. 7 is a flow diagram illustrating a process used in some implementations of the present technology for provisioning an edge system for an edge assisted virtual call.

FIG. 8 is a flow diagram illustrating a process used in some implementations of the present technology for performing an edge assisted virtual call.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to edge assisted virtual calling with visual user presence. Virtual calls that include a visual user presence, such as holographic calling or a virtual call with user avatars, leverage image processing to generate the visual data for rendering the user holograms and/or user avatars. Such image processing can consume large quantities of computing resources from the participating user systems, thus reducing the practicality of these virtual calls. Implementations provide edge assistance for virtual calls with a visual user presence. For example, edge system(s) can be selected and provisioned to assist participating user systems. The edge assistance can include image processing to generate the visual data for rendering user holograms and/or user avatars. In some implementations, a call module at the edge system can perform call functions for the virtual call, such as ringing target user systems and establishing communication channels for the flow of call data.

In an example call initiation flow, a source user operating a source system can identify one or more users for a virtual call. In some implementations, the source user can initiate the virtual call via a collaboration tool that supports interactions (e.g., virtual calls, messaging, etc.) among users. A call manager at the source system can transmit a software call to an orchestrator system that orchestrates user requests for edge systems. In some implementations, the orchestrator is connected to one or more edge controllers, each of which manages a plurality of edge systems. The software call transmitted to the orchestrator system can be a request for edge assistance on a virtual call.

In some implementations, the orchestrator can request, from an edge controller, edge assistance for the virtual call comprising the source system. The edge controller can select an edge system from among a plurality of edge systems for the edge assistance. For example, the edge controller can select the edge system based on available computing resources (e.g., storage, processor utilization, etc.), proximity to the source system, latency criteria, and other suitable factors. The edge controller can then provision the selected edge system for the edge assistance. The provisioning can include provisioning software modules for the edge assistance, such as one or more engines for performing the image processing and a call module for performing call functionality related to the virtual call. The provisioning can also include loading workload resources (e.g., trained machine learning models) that perform workloads for image processing and/or visual presence generation (e.g., visual data for a user hologram or a user avatar), such as face tracking, expression tracking, hand/finger tracking, lip synching, etc).

Once the selected edge system is provisioned, the edge controller can provide the edge system's networking information (e.g., internet protocol (IP) address, port(s), etc.) to the orchestrator, and the orchestrator can relay the information to the source system. The source system can then connect to the selected edge system using the provided networking information and transmit a virtual call initiation command to the edge system. For example, the command can include the type of virtual call (e.g., holographic call, virtual call with avatar(s), etc.) and the target users. The edge system can then transmit virtual call request(s) to the target users via the call module provisioned at the edge system. In other words, the call module at the edge system can “ring” the various target systems affiliated with the target users.

In some implementations, a target user can accept the call request with the source user and the target user system can similarly request edge assistance from the orchestrator for the virtual call. Using techniques similar to those disclosed with reference to the source system, orchestrator, edge controller, and selected edge system, the orchestrator can issue a request for edge assistance for the target user system to the edge controller. The edge controller can then select and provision another edge system that provides edge assistance to the target user system for the virtual call.

Once the call modules of the edge systems have established the logical connections for the virtual call, call data can be communicated back and forth between the source system and the target system via the edge system and the other edge system. Implementations of the edge system can receive, from the source system, images of the source user, such as two-dimensional images captured by an artificial reality system. In some cases, the images can be from multiple cameras at different perspectives (e.g., stereoscopic images). Using the images of the source user, the edge system can perform workloads on the images via the provisioned engine(s) and loaded workload resource(s) to generate visual data for the source user, such as depth augmented images. The edge system's engine(s) can then provide the visual data to the edge system's call module, which can stream the visual data for the source user to the target system. For example, the visual data for the source user can be data for rendering a visual presence for the source user, such as a hologram of the source user and/or an avatar for the source user.

In some implementations, the rendered visual presence of the source user can be part of the virtual call. For example, images of the target user can be received at the other edge system from the target system, the other edge system can generate, via provisioned engine(s) and loaded workload resources, visual data for the other user, and the visual data of the other user can be streamed, via a provisioned call module at the other edge system, to the source system for rendering. In some implementations, the communications between the edge system, source system, another edge system, and target system are implemented using one or more real-time communication (RTC) channels.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Conventional calling services are either limited in the type of user presence supported during a call or consume a large quantity of computing resources at the user systems to support additional types of user presence. For example, conventional calling services support video calls with a two-dimensional user presence. Conventional hologram services that support additional types of user presence, such as a user hologram, do so by performing heavy computing workloads on the users' systems, which can lead to several drawbacks. For example, hologram services that perform the workloads at the user systems are limited to end-user systems with compute, battery, and/or memory resources capable of performing such workloads. These conventional systems limit the types of systems/devices that can implement the hologram service. In addition, hologram services that perform workloads on a cloud system suffer from latency drawbacks that limit the capabilities of the service. For example, hologram workloads that are offloaded to a cloud system will fail to achieve a latency for the communications that supports real-time holographic calling.

Implementations select edge system(s) for edge assistance during a call. Compute workloads for generating visual data of a user is offloaded to the selected edge system(s). The edge system(s) are selected such that latency for the communication between a source system and a target system (via the edge system(s)) meets a latency criteria for real-time calling. In addition, because the visual data generation workloads are offloaded to an edge system, a larger variety of end-user systems (e.g., source systems and target systems) can participate in the calling services, such as end-user systems with limited compute, memory, and/or battery resources.

In some implementations, hologram workloads are parallelized across multiple cores of GPU(s) at the target system. For example, when an engine or runtime that supports parallel execution of workloads is detected at an edge system, the engine/runtime can be used to parallelize hologram workloads across multiple cores of GPU(s). This further increases the speed of performance for the hologram workloads and further reduces the end-to-end latency for communication between the source system and target system via the edge system. In these implementations, compute power at the edge system (e.g., multi-core GPUs) can support hologram services at end-user systems (e.g., the source system and/or target system) that lack this type of compute power.

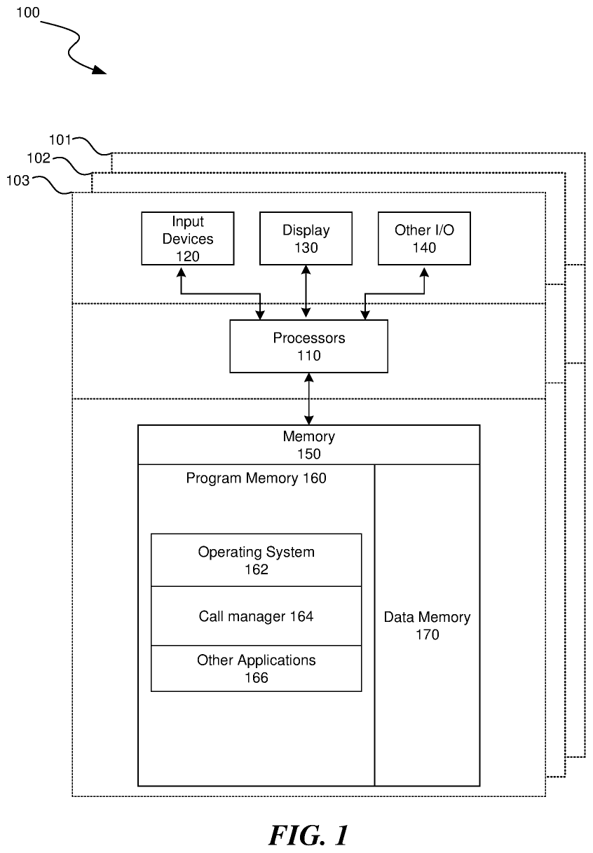

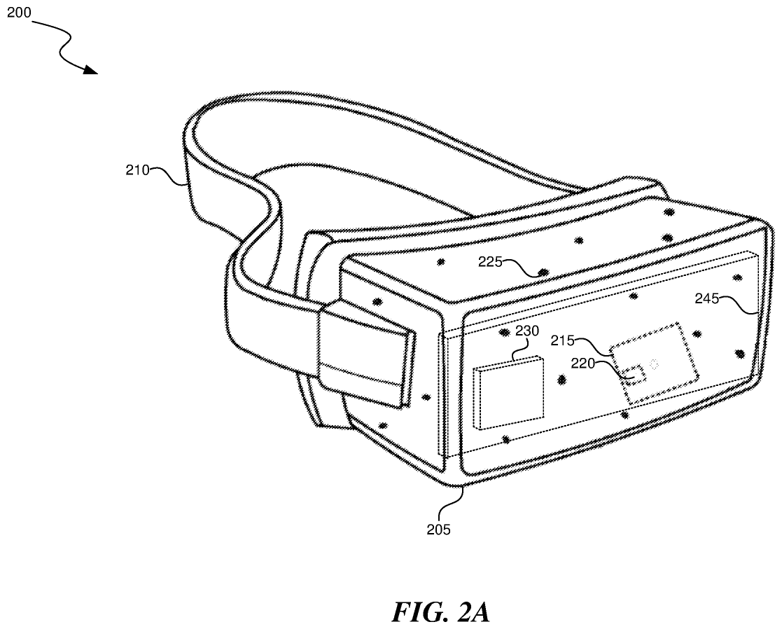

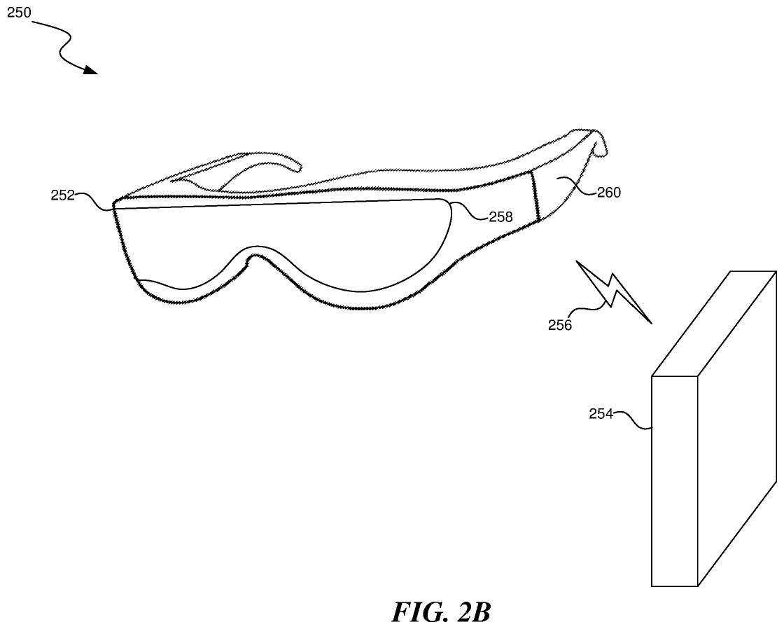

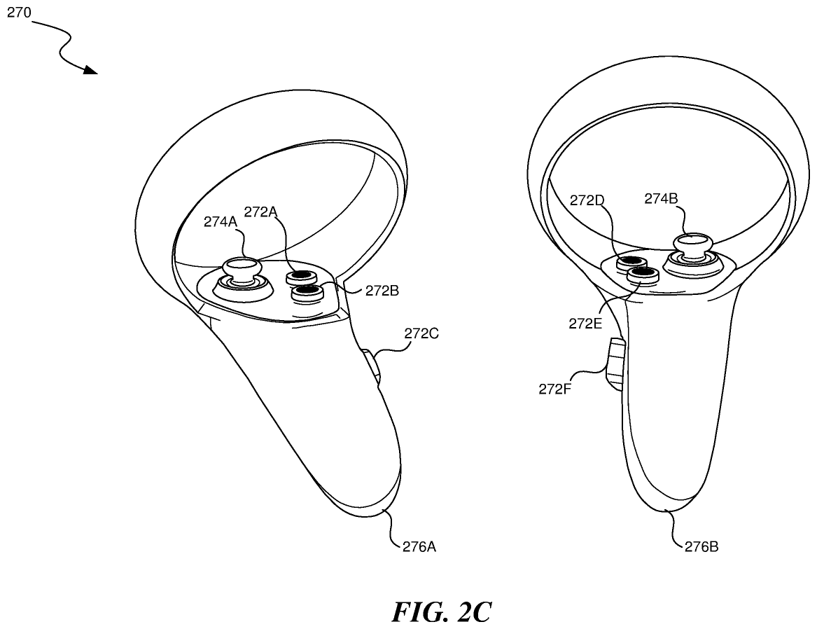

Several implementations are discussed below in more detail in reference to the figures. FIG. 1 is a block diagram illustrating an overview of devices on which some implementations of the disclosed technology can operate. The devices can comprise hardware components of a computing system 100 that augment images with depth information to support hologram display. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, call manager 164, and other application programs 166. Memory 150 can also include data memory 170 that can include, e.g., codecs, protocol implementation software, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

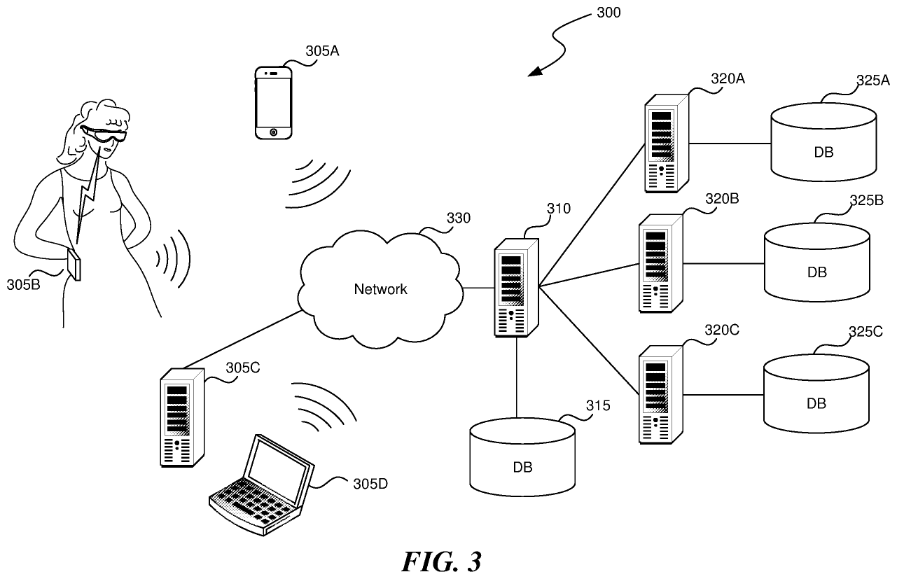

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

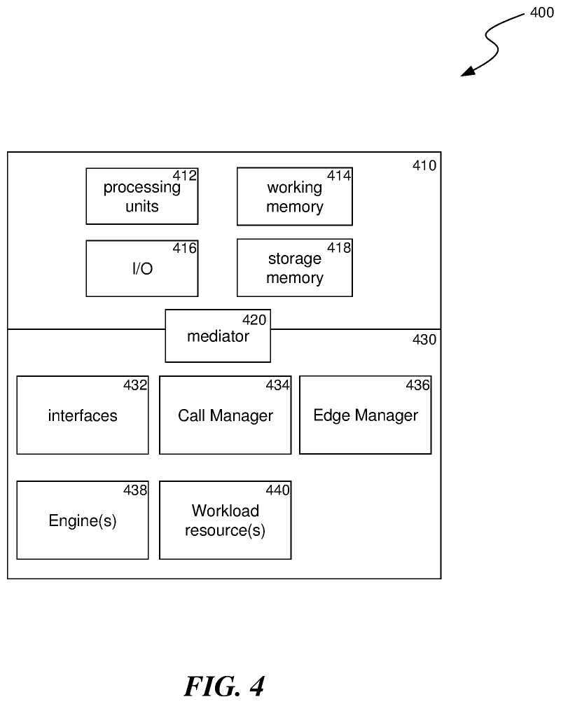

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems. Specialized components 430 can include software or hardware configured to perform operations for performing edge assisted virtual calling with visual user presence. Specialized components 430 can include call manager 434, edge manager 436, engine(s) 438, and workload resource(s) 440, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

Call manager 434 can manage virtual call(s) among participating user systems and/or implementing edge systems. For example, an originating user system can initiate a virtual call with one or more participating user systems. In some implementations, a user system can join an ongoing virtual call. One or more edge systems can assist the virtual call, such as by performing visual data processing for the virtual call. In some implementations, different computing systems can include components of call manager 434 that support the virtual call, such as the originating user system, edge system(s), participating user system(s), or any other suitable computing systems. Implementation of call manager 434 can be modules of a calling framework, such as Rsys, a WebRTC call framework, or any other suitable calling framework.

In some implementations, the virtual call can include a visual user presence (e.g., avatar, hologram, etc.) for one or more participants. Edge system(s) can process images of participating user(s) to generate visual data for rendering the user's visual presence, and call manager 434 component(s) at the edge system(s) can stream the visual data to participating user system(s) for rendering. In some implementations, a component of call manager 434 at an originating user system can transmit a call request to a supporting edge system for a virtual call with participating user system(s). A component of call manager 434 at the supporting edge system can, in response to the call request, ring the participating user system(s) to initiate the virtual call.

In some implementations, a participating user system can accept the request, and the participating user system can request edge assistance for the virtual call. For example, another supporting edge system can provide the participating user system edge assistance during the call. The other supporting edge system can also include a call manager 434 component that performs call functionality for the other supporting edge system. Implementations of call manager 434 components at one or more of the originating user system, supporting edge system(s), and/or participating user system can create logical network connections (e.g., real-time communication channels) for communicating call data among these systems.

Edge manager 436 can manage edge system(s) that support virtual calls among participating user systems. Edge manager 436 can select edge system(s) to assist virtual call(s) to balance load among available resource, provision software component(s) at select edge system(s), and/or coordinate connections among user system(s) and edge system(s).

Engine(s) 438 can be any suitable engine for processing virtual call data. For example, engine(s) 438 can perform machine learning workload(s) on image data for virtual calls, estimate depth information from images (e.g., stereoscopic images, single source images, etc.), or perform other suitable image processing. Engine(s) 438 can be located at a source system, edge system, and/or target system. Examples of engine(s) 436 include versions(s) of Spark AR engine, versions(s) of Spark AR Studio, or any other suitable processing engine for visual frames.

In some implementations, engine(s) 438 includes one or more runtime environments, such as a Compute Unified Device Architecture (CUDA) runtime, TensorFlow runtime, TensorRT runtime, and other suitable runtime environments. Some example runtimes at engine(s) 438 can parallelize workloads across multiple cores of GPU(s). Some example runtimes at engine(s) 438 can perform workloads using one or more cores of CPU(s). Some runtimes at engine(s) 438 can parallelize performance of one or more portions of the ordered pipeline, for example for different batches of images, across multiple cores of GPU(s). Some runtimes at engine(s) 438 perform the ordered pipeline in sequence using one or more CPU(s).

Workload resource(s) 440 can be resources that configure software (e.g., engine(s) 438) to process visual data. In an example, workload resource(s) 440 can be a trained machine learning model configured to perform a workload on a visual frame, various 2D or 3D models, audio content, kinematic models, mapping or location data (e.g., SLAM data), etc. Example workload resource(s) 440 can be one or more trained machine learning models configured to process visual frames (e.g., stereoscopic frames, signal source frames, etc.) and estimate depth information and/or a mesh structure.

Workload resource(s) 440 can be any other suitable resource (e.g., model, software, etc.) for performing a workload on visual data. Workload resource(s) 440 can be preloaded at edge systems, source systems, and/or target systems such that a workload can be performed on visual frames by an engine (e.g., engine(s) 438) using the preloaded resources. Workload resources 440 can include convolutional neural networks, deep convolutional neural networks, very deep convolutional neural networks, transformer networks, encoders and decoders, generative adversarial networks (GANS), and other suitable machine learning components.

A “machine learning model,” as used herein, refers to a construct that is configured (e.g., trained using training data) to make predictions, provide probabilities, and/or augment data. For example, training data for supervised learning can include items with various parameters and an assigned classification. A new data item can have parameters that a model can use to assign a classification to the new data item. Examples of models include: neural networks, support vector machines, Parzen windows, Bayes, clustering models, reinforcement models, probability distributions, decision trees, decision tree forests, and others. Machine learning models can be configured for various situations, data types, sources, and output formats.

In some implementations, a machine learning model can include one or more neural networks, each with multiple input nodes that receive one or more representations of images. The input nodes can correspond to functions that receive the input and produce results. These results can be provided to one or more levels of intermediate nodes that each produce further results based on a combination of lower level node results. A weighting factor can be applied to the output of each node before the result is passed to the next layer node. At a final layer, (“the output layer”) one or more nodes can produce an output that, once the model is trained, represents a modified version of the input image(s) and/or represents depth information. In some implementations, such neural networks, known as deep neural networks, can have multiple layers of intermediate nodes with different configurations, can be a combination of models that receive different parts of the input and/or input from other parts of the deep neural network, and/or can be a recumbent model (partially using output from previous iterations of applying the model as further input to produce results for the current input).

An example workload resource 440 can be a machine learning model comprising an encoder that converts one or more images (depicting a user) to model input (i.e., an “encoded image”) and a geometry projection branch that can, based on the encoded image, predict a geometry (3D mesh) of the user. In some cases, the machine learning model can also be a recumbent model, using the output of one or more previous iterations in the prediction for a next iteration. Implementations of the machine learning model can also include one or more convolutional layers that process the one or more images.

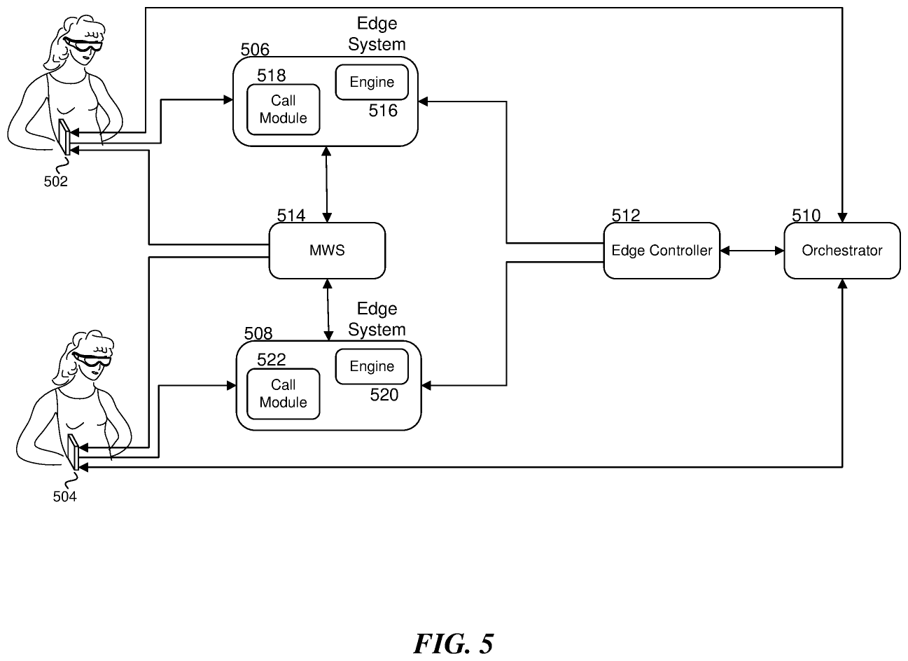

Implementations provision an edge system to perform an edge assisted virtual call. FIG. 5 is a system diagram illustrating components for edge assisted virtual calling from a source system to a target system. System 500 includes source system 502, target system 504, edge systems 506 and 508, orchestrator 510, edge controller 512, multi-way service 514, engines 516 and 520, and call modules 518 and 522. Source system 502 and target system 504 can be any suitable computing system that can implement a virtual call with a visual user presence (e.g., video call, holographic call, call with avatar user representation, etc.), such as devices with two-dimensional displays (e.g., laptop, smartphone, tablet, smart home device with a display, etc.), devices with three-dimensional displays (e.g., XR systems), or any other suitable computing systems. In some implementations, call module 518, call module 522, and call module(s) at source system 502 and target system 504 (not depicted) are configured to interact with one another to perform a virtual call. For example, these modules can be components of RSYS, a calling framework that can be used to perform virtual calls with visual user presence, or any other suitable calling framework.

Source system 502 can communicate with orchestrator 510 to request an edge system for a virtual call. For example, orchestrator 510 can expose an API to source system 502 that supports edge assistance requests. Source system 502 can request an edge system via communication with orchestrator 510 using any other suitable communication. Orchestrator 510 can issue commands to edge controller 512 for an edge system for source system 502's edge assistance request. In some implementations, based on commands from orchestrator 510, edge controller 512 can select edge system 506 from among a plurality of edge system for the virtual call assistance. For example, edge controller 512 can select edge system 506 based on one or more of: location proximity to source system 502, load balancing/available resource capacity among edge systems managed by edge controller 512, latency requirements, and other suitable factors.

Once edge system 506 is selected, edge controller 512 can provision software components at edge system 506, such as engine 516 and call module 518. Edge controller 512 can also provision an architecture for engine 516 and call module 518, such as a data flow that defines the following example sequence: call data is input to engine 516; and output from engine 516 is input to call module 518. Edge controller 512 can also load one or more workload resources, such as trained machine learning models, that perform workload(s) for an edge assisted call. Once edge controller 512 provisions edge system 506 and/or loads the workload resource(s), edge controller 512 can provide the edge system's networking information (e.g., internet protocol (IP) address, port, etc.) to orchestrator 510, which in turn can provide edge system 506's networking information to source system 502.

Source system 502 can then connect to edge system 506 using the provided networking information and request a virtual call with target system 504. Call module 518 of edge system 506 can, in response to the call request from source system 502, transmit a call initiation request (“ring”) to target system 506. When target system 506 accepts the call request, target system 506 can communicate with orchestrator 510 to request an edge system for the accepted call. Similar to the selection and provisioning of edge system 506 for source system 504, orchestrator 510 and edge controller 512 can: select edge system 508 for target system 504; provision edge system 508 with engine 520 and call module 522; and load workload resource(s) that perform workload(s) for the edge assisted call.

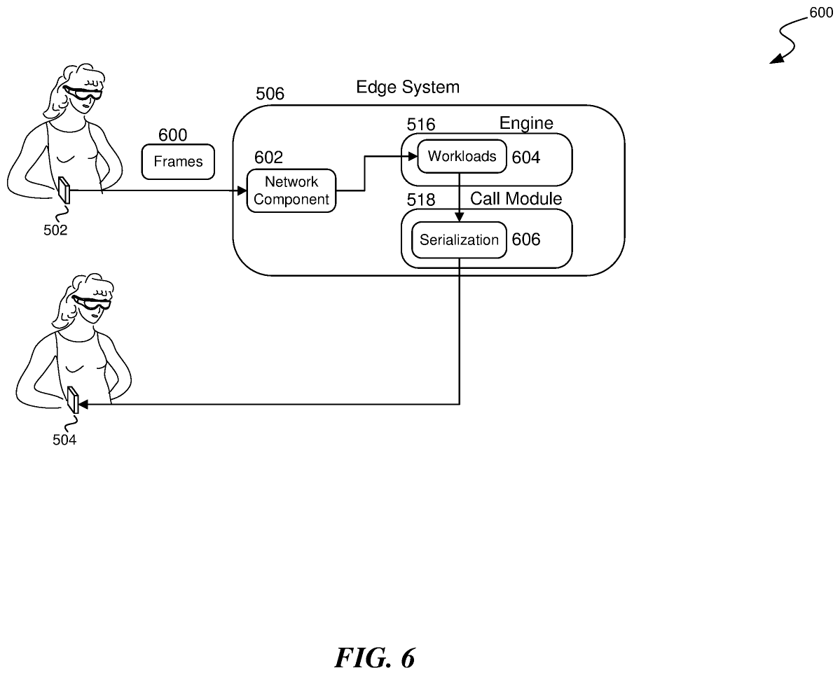

In some implementations, the call between source system 502 and target system 504 can be a call with a visual depiction of the user(s) of these systems. In this example, source system 502 can transmit call data comprising visual frames (captured by camera(s) at source system 502) to edge system 506 for processing. FIG. 6 is a diagram of an edge assisted workflow for processing visual frames during an edge assisted virtual call. Diagram 600 includes source system 502, target system 504, edge system 506, engine 516, call module 518, frames 600, network component 602, workloads 604, and serialization 606.

Once a call is established via source system 502, target system 504, orchestrator 510, edge controller 512, edge system 506, and edge system 508, as disclosed with reference to FIG. 5, call information can be transmitted from source system 502 to target system 504 via edge system 506. Frames 600 can be captured via one or more cameras at source system 502 and transmitted to edge system 506, such as over a real-time communication channel (e.g., webRTC, etc.). Frames 600 can be visual frames of a user captured from one or more perspectives.

Network component 602 of edge system 506 can receive frames 600 and communicate them, as input, to engine 516. Engine 516 can perform workloads 604 on frames 600 to generate visual data of the user. The visual data can comprise data that supports rendering of a visual presence for the user, such as a hologram, three-dimensional display, and/or user avatar. Example visual data can be depth encoded frames, avatar information (e.g., pose data, skeleton, textures, etc.), a three-dimensional structure (e.g., mesh), or any other suitable visual data.

In some implementations, engine 516 can perform workloads 604 that generate visual data for rendering a hologram of a user or a three-dimensional representation of a user (e.g., avatar). For example, engine 516 can buffer images 600 for processing (e.g., temporally synchronize images from different perspectives, buffer single perspective images, etc.), estimate depth from images 600, and generate a mesh structure using the estimated depth data. One or more machine learning models can be trained/configured to estimate depth for images. For example, such a model can be trained using images taken simultaneously with a depth camera and 2D camera, where the image from the 2D camera is provided to the model and the output of the model is compared to the depth camera image and, based on the comparison, the model parameters are updated.

In various implementations, engine 516 can generate depth data procedurally used to generate a mesh structure and/or workload resource(s) (e.g., trained machine learning models) can be used to take depth data and produce a mesh. In some implementations, the generated mesh structure represents a mesh of a user included in images 600. In some implementations, the generated mesh includes a texturized layer (e.g., skin) that supports hologram display. Any other suitable techniques can be implemented to estimate depth and generate a mesh using images 600. In some implementations, the visual data of the user generated by engine 516 can include images encoded with depth information which can be representative of a mesh structure and/or three-dimensional structure. For example, the edge system can augment color values (e.g., RGB pixel values) with depth information to encode the images with the depth information. Any other suitable technique to encode two-dimensional images with depth information can be implemented.

The visual data of the user output from engine 516 (e.g., depth encoded images, etc.) can be provided to call module 518, which can perform serialization 606. For example, serialization 606 can include serializing the visual data of the user output from engine 516 for streaming to target system 504 via one or more real-time communication channels (e.g., webRTC channels, MediaChannel, etc.). In some implementations, serialization 606 can include splitting the visual data of the user into visual frames (e.g., RGB frames streamed over a first channel, such as a first webRTC communication channel, etc.) and depth information (e.g., depth data streamed over a second channel, such as a MediaChannel, second webRTC communication channel, etc.).

In some implementations, engine 516 and performed workloads 604 can transform the visual data of the user in accordance with a configuration of call module 518 and performance of serialization 606. For example, engine 516 can generate visual display data as visual frames (e.g., RGB frames) and depth information. Engine 516 can transform the visual frames and depth information into a stitched format that provides call module 518 a single input data stream (e.g., stitched RGB frames plus depth information). Call module 518 and the performed serialization 606 can de-stitch the single data stream to segregate the visual frames from the depth information such that these components can be streamed to target system 504 via separate communication channels.

Implementations of engine 516 and performed workloads 604 can generate visual data of the user in any suitable structure and/or format (e.g., visual frames with encoded depth information, visual frames and separate depth information, a mesh structure, etc.). Implementations of call module 518 and performed serialization 606 can take, as input, any suitable structure and/or format of visual data, transform the visual data in any suitable manger, and/or stream the visual data to target system 504 using any suitable techniques (e.g., via a single channel, via multiple channels, etc.).

Returning to FIG. 5, target system 504 can similarly transmit visual frames to edge system 508 for processing, via engine 520, and call module 522 can transmit the generated visual data (e.g., depth encoded frames) to source system 502. Source system 502 can display a visual representation of the user of target system 504 during the call using the visual data streamed from edge system 506 and target system 504 can display a visual representation of the user of source system 502 during the call using the visual data streamed from edge system 506. Implementations offload visual data processing from source system 502 and target system 504 onto edge systems 506 and 508, respectively. In some examples, orchestrator 510 and edge controller 512 select and provision edge systems 506 and 508 to provide edge assistance to source system 502 and target system 504 for the call. The edge assistance for the call can include processing captured frames to generate visual display data, such as depth encoded frames, a mesh structure, avatar information, or other suitable visual display data.

In some implementations, the visual data generated by edge system 506 and edge system 508 can be transmitted to multi-way service 514 for transmission to participating systems of the call. For example, multi-way service 514 can be a distribution or fanout service that receives call data from participating user systems (e.g., source system 502, target system 504, and other participating user systems) and/or edge systems that assist the participating user systems (e.g., edge systems 506 and 508, and edge systems that assist other participating user systems), and distributes the call data to the participating user systems. In some implementations, multi-way service 514 can include a signaling multi-way service and a media multi-way service. The signaling multi-way service can establish communication channels with participating user systems and/or edge systems that assist the participating user systems. The media multi-way service can receive call data from the participating user systems and/or edge systems and distribute call data to the participating user systems and/or edge systems.

Those skilled in the art will appreciate that the components illustrated in FIGS. 1-6 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

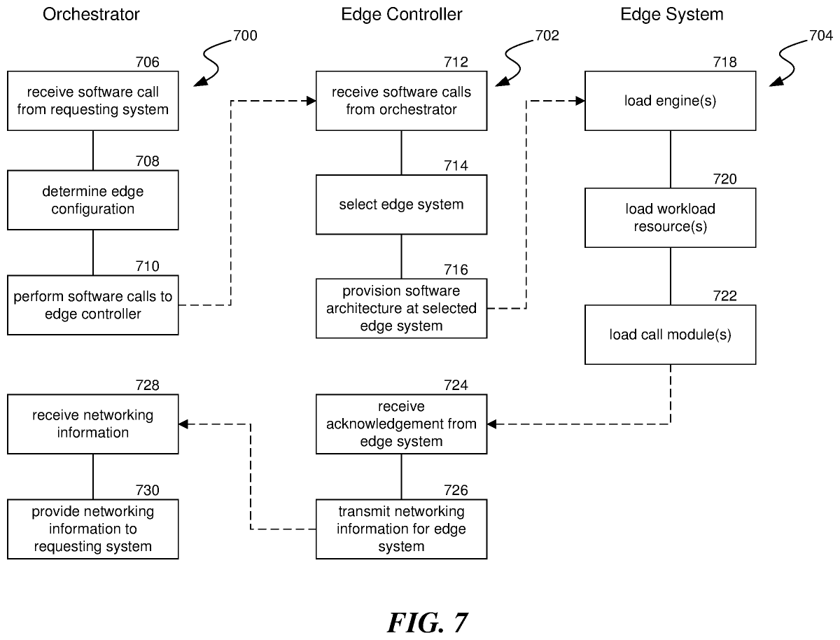

FIG. 7 is a flow diagram illustrating a process used in some implementations of the present technology for provisioning an edge system for an edge assisted virtual call. In some implementations, processes 700, 702, and 704 can be triggered by a source system request for an edge service to support a virtual call. Blocks 706, 708, 710, 728, and 730 of process 700 can be implemented at an orchestrator system, blocks 712, 714, 716 724, and 726 of process 702 can be implemented at an edge controller, and blocks 718, 720, and 722 can be implemented at an edge system.

At block 706, process 700 can receive a request for edge system(s) to assist with a virtual call. For example, an orchestrator system can receive a request from a requesting system for edge assisted virtual call functionality. In some implementations, the request can comprise an API call from the source system to the orchestrator system.

At 708, process 700 can determine an edge configuration for the request. For example, the orchestrator can determine that the request comprises an edge assistance request for a virtual call. In some implementations, the orchestrator determines edge resources for the edge assistance, such as software modules to provision (e.g., engines, call modules, etc.), a configuration for the software modules (e.g., data flow sequence), and workload resources to load (e.g., trained machine learning models). In some implementations, an edge controller can determine one or more of the software modules to provision, configuration for the software modules, and/or workload resources to load.

At 710, process 700 can perform a software call to provide commands to an edge controller. For example, the orchestrator can issue commands to the edge controller for an edge system for the requested edge assistance. In some implementations, the software call to the edge controller can include one or more of: software modules to provision, configuration for the software modules, and/or workload resources to load.

At 712, process 702 can receive the software calls from the orchestrator. For example, the edge controller can receive the orchestrator's commands that request an edge system to assist the requesting system's virtual call. At 714 process 702 can select an edge system from among a plurality of edge systems. For example, the edge controller can manage a plurality of edge systems, and the edge controller can select an edge system from among these edge systems based on: proximity to the requesting system, load on the edge systems, latency requirements, and other suitable factors.

At 716, process 702 can provision software architecture at selected edge system. For example, the edge controller can provision a software architecture at the selected edge system that includes engine(s), call module(s), and an architecture for the engine(s) and call module(s). In some implementations, the selected architecture defines a call data flow among the selected software components and the edge controller can provision the software components according to the selected architecture. The edge controller can also load workload resource(s) (e.g., trained machine learning models) that perform workloads to deliver the edge assistance for the virtual call.

At 718, process 704 can load engine(s) in response to commands from the edge controller. For example, the edge controller can issue commands to provision engine(s) at the edge system. At 720, process 704 can load workload resource(s) in response to commands from the edge controller. For example, the edge controller can issue commands to load workload resource(s) at the edge system. At 722, process 704 can load call module(s) in response to commands from the edge controller. For example, the edge controller can issue commands to provision call module(s) at the edge system. In some implementations, the commands from the edge controller can provision the engine(s) and call module(s) in accordance with an architecture that flows call data in accordance with the following example sequence: visual frames are input to the engine(s); and visual data output from the engine(s) is input to the call module(s).

At block 724, process 702 can receive acknowledgement(s) from the edge system. For example, the edge controller can confirm that the selected edge system is provisioned for edge assistance. At block 726, process 702 can transmit networking information for the edge system to the orchestrator. At block 728, process 700 can receive the networking information for the edge system. At block 730, process 700 can transmit the networking information for the edge system to the requesting system. For example, the orchestrator can provide the requesting system the network information that permits the requesting system to connect with the selected edge system for performing the edge assisted call.

In some implementations, the source system can initiate a virtual call with the target system via the selected and provisioned edge system. For example, the source system can connect to the selected edge system using the provided networking information and request a virtual call with target system. A call module provisioned at the edge system can, in response to the call request, transmit a call initiation request (“ring”) to the target system. When the target system accepts the call request, the target system and/or selected edge system can communicate with an orchestrator to request another edge system for the accepted call (e.g., for the target system). Similar to the selection and provisioning of the edge system for the source system, the orchestrator and edge controller can: select an other edge system for the target system; provision the other edge system with software components (e.g., an image processing engine and/or a call module); and load workload resource(s) that perform workload(s) for the edge assisted call. In some implementations, the edge system can provide edge assistance to the source system for the virtual call and the other edge system can provide edge assistance to the target system for the virtual call.

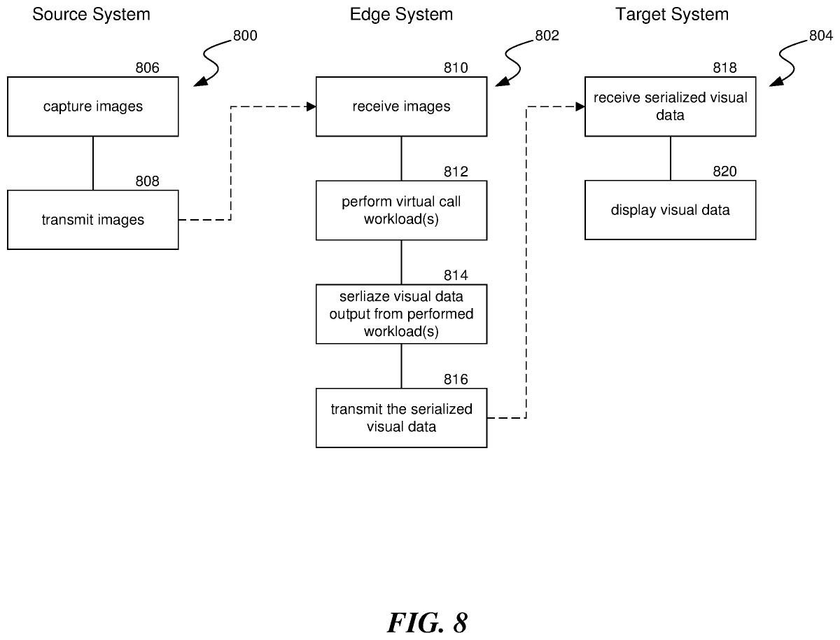

FIG. 8 is a flow diagram illustrating a process used in some implementations of the present technology for performing an edge assisted virtual call. In some implementations, processes 800, 802, and 804 can be triggered by a source system request for an edge assisted virtual call. Blocks 806 and 808 of process 800 can be implemented at a source system, blocks 810, 812, 814, and 816 of process 802 can be implemented at an edge system, and blocks 818 and 820 can be implemented at a target system.

At block 806, process 800 can capture images. For example, a source system for a call can be a user computing system with one or more cameras for capturing the user of the computing system. The source system can be any suitable computing system that can implement a virtual call with a visual user presence (e.g., video call, holographic call, call with avatar user representation, etc.), such as devices with two-dimensional displays (e.g., laptop, smartphone, tablet, smart home device with a display, etc.), devices with three-dimensional displays (e.g., XR systems), or any other suitable computing systems.

At block 808, process 800 can transmit images to an edge system. For example, an edge system can be selected and provisioned to perform edge assistance for the source system's call with a target system. In some implementations, the edge system can be selected and provisioned via processes 700, 702, and 704 of FIG. 700. The source system can transmit the captured images to the edge system as call data.

At block 810, process 802 can receive the images from the source system. For example, the received images can comprise two-dimensional images of the source system's user from one or more perspectives. The received images can comprise any other suitable images.

At block 812, process 802 can perform workload(s) on the received images. For example, engine(s) provisioned at the source system can generate visual data, using the received images of the user, for rendering a three-dimensional hologram of the user and/or an avatar of the user. The engine(s) can generate the visual data by performing workload(s) on the received images using one or more loaded workload resources (e.g., trained machine learning models). At block 814, process 802 can serialize the visual data output from the performed workload(s). For example, the visual data can be serialized in any suitable manner such that a call module from the edge system can stream the data to a call module at the target system.

At block 816, process 802 can transmit the serialized visual data to the target system. For example, the serialized visual data can be streamed to the target system over any suitable real-time communication channel. In some implementations, the serialized visual data is split into two data streams, and the two data streams are transmitted to the target system over two different real-time communication channels.

At block 818, process 804 can receive the serialized visual data. For example, the target system can be a participating system on the source system's call. The target system can be any suitable computing system that can implement a virtual call with a visual user presence (e.g., video call, holographic call, call with avatar user representation, etc.), such as devices with two-dimensional displays (e.g., laptop, smartphone, tablet, smart home device with a display, etc.), devices with three-dimensional displays (e.g., XR systems), or any other suitable computing systems.

At block 820, process 804 can display the visual data as a user presence. For example, the visual data can be rendered as a hologram of the user of the source system, an avatar of the user, or as any other suitable visual presence for the user. In some implementations, the target system can be an XR system with a HMD, and a hologram of the user can be displayed using the XR system. The target system can be any other suitable system capable of displaying a hologram. Additional details on depth estimation, model generation, encoding/decoding, rendering, and display are provided in U.S. patent application Ser. No. 17/360,693, titled Holographic Calling for Artificial Reality, filed Jun. 28, 2021, which is herein incorporated by reference in its entirety.

In some implementations, an other edge system selected and provisioned for the target system can similarly process captured images for the target system during the virtual call. For example, the other edge system can: receive, from the target system, images of an other user; perform, using an other provisioned image processing engine, a processing workload on the received images to generate visual data of the other user; serialize, using an other provisioned virtual call component, the visual data of the other user; and transmit, using the provisioned other virtual call component, the serialized visual data of the other user. The source system can receive the serialized visual data of the other user and render the serialized visual data of the other user as a visual representation of the other user for the virtual call.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for performing edge assisted virtual calling with visual user presence, the method comprising:
receiving, at an edge system in a network and from a source system, a request to initiate a virtual call between the source system and a target system;
initiating the virtual call with the target system by transmitting, from the edge system to the target system, a call request using a provisioned virtual call component, provisioned to the edge system;
receiving, at the edge system from the source system, images of a user;
generate visual data of the user by performing, at the edge system using an image processing engine and one or more selected workload resources provisioned to the edge system, a processing workload on the received images;
serializing, at the edge system using the provisioned virtual call component, the visual data of the user; and
transmitting, from the edge system using the provisioned virtual call component, the serialized visual data of the user, wherein the target system receives the serialized visual data of the user and renders the serialized visual data of the user as a visual representation of the user for the virtual call.

2. The method of claim 1, wherein the visual data of the user generated by performing the processing workload on the received images comprises depth information, and the visual representation of the user for the virtual call generated at the target system comprises an avatar or a hologram of the user.

3. The method of claim 2, further comprising:
transforming, at the edge system using the provisioned image processing engine, the generated visual data of the user into depth encoded visual frames, wherein the provisioned virtual call component serializes the visual data of the user by serializing the depth encoded visual frames.

4. The method of claim 1, wherein the provisioning of the provisioned virtual call component, the image processing engine, and the one or more selected workload resources to edge system is performed by an edge controller.

5. The method of claim 4, wherein the edge controller is configured to:
receive, at the edge controller from the source system, a request for virtual calling edge assistance;
select, in response to the request for virtual calling edge assistance, the edge system and software components; and
provision, to the selected edge system, the software components, wherein the provisioned software components comprise the image processing engine and the virtual call component.

6. The method of claim 5, wherein the edge controller is further configured to:
transmit, from the edge controller to the source system, networking information for the selected edge system in response to the provisioning.

7. The method of claim 5, wherein, in response to the request for virtual calling edge assistance, the edge controller selects an architecture that defines a data flow among the selected software components.

8. The method of claim 5, wherein the selecting, by the edge controller, the edge system is performed by:
determining, for a plurality of candidate edge systems that includes the edge system, available resource capacity and location proximity to the source system; and
selecting the edge system from the plurality of candidate edge systems for the source system based on its location proximity to the source system and its available resource capacity.

9. The method of claim 5, wherein the target system accepts the call request from the virtual call component, and, in response to the acceptance of the call request, the edge controller configures edge assistance for the target system by:
selecting an other edge system for the target system; and
provisioning, to the other edge system, an other image processing engine and an other virtual call component.

10. The method of claim 9, wherein the other edge system is configured to:
receive, from the target system, images of an other user;
perform, using the provisioned other image processing engine, a processing workload on the received images to generate visual data of the other user;
serialize, using the other provisioned virtual call component, the visual data of the other user; and
transmit, to the source system using the provisioned other virtual call component, the serialized visual data of the other user, wherein the source system receives the serialized visual data of the other user and renders the serialized visual data of the other user as a visual representation of the other user for the virtual call.

11. A computer-readable storage medium storing instructions that, when executed by a computing system, cause the computing system to perform a process for performing edge assisted virtual calling with visual user presence, the process comprising:
receiving, at an edge system in a network and from a source system, a request to initiate a virtual call between the source system and a target system;
initiating the virtual call with the target system by transmitting, from the edge system to the target system, a call request using a provisioned virtual call component, provisioned to the edge system;
receiving, at the edge system from the source system, images of a user;
generate visual data of the user by performing, using an image processing engine provisioned to the edge system, a processing workload on the received images;
serializing, using the provisioned virtual call component, the visual data of the user; and
transmitting, using the provisioned virtual call component, the serialized visual data of the user, wherein the target system receives the serialized visual data of the user and renders the serialized visual data of the user as a visual representation of the user for the virtual call.

12. The computer-readable storage medium of claim 11, wherein the visual data of the user generated by performing the processing workload on the received images comprises depth information, and the visual representation of the user for the virtual call generated at the target system comprises an avatar or a hologram of the user.

13. The computer-readable storage medium of claim 12, wherein the process further comprises:
transforming, at the edge system using the provisioned image processing engine, the generated visual data of the user into depth encoded visual frames, wherein the provisioned virtual call component serializes the visual data of the user by serializing the depth encoded visual frames.

14. The computer-readable storage medium of claim 11, wherein the provisioning of the provisioned virtual call component and the image processing engine to edge system is performed by an edge controller.

15. The computer-readable storage medium of claim 14, wherein the edge controller is configured to:
receive, at the edge controller from the source system, a request for virtual calling edge assistance;
select, in response to the request for virtual calling edge assistance, the edge system and software components; and
provision, to the selected edge system, the software components, wherein the provisioned software components comprise the image processing engine and the virtual call component.

16. The computer-readable storage medium of claim 15, wherein, in response to the request for virtual calling edge assistance, the edge controller selects an architecture that defines a data flow among the selected software components.

17. The computer-readable storage medium of claim 15, wherein the selecting, by the edge controller, the edge system is performed by:
determining, for a plurality of candidate edge systems that includes the edge system, available resource capacity and location proximity to the source system; and
selecting the edge system from the plurality of candidate edge systems for the source system based on its location proximity to the source system and its available resource capacity.

18. The computer-readable storage medium of claim 15, wherein the target system accepts the call request from the virtual call component, and, in response to the acceptance of the call request, the edge controller configures edge assistance for the target system by:
selecting an other edge system for the target system; and
provisioning, to the other edge system, an other image processing engine and an other virtual call component.

19. The computer-readable storage medium of claim 18, wherein the other edge system is configured to:
receive, from the target system, images of an other user;
perform, using the other provisioned image processing engine, a processing workload on the received images to generate visual data of the other user;
serialize, using the other provisioned virtual call component, the visual data of the other user; and
transmit, to the source system using the provisioned other virtual call component, the serialized visual data of the other user, wherein the source system receives the serialized visual data of the other user and renders the serialized visual data of the other user as a visual representation of the other user for the virtual call.

20. An edge computing system for performing edge assisted virtual calling with visual user presence, the edge computing system comprising:
one or more processors; and
one or more memories storing instructions that, when executed by the one or more processors, cause the edge system to perform a process comprising:
receiving, from a source system, a request to initiate a virtual call between the source system and a target system;
initiating the virtual call with the target system by transmitting, from the edge system to the target system, a call request using a provisioned virtual call component;
receiving images of a user;
generate visual data of the user by performing, using an image processing engine provisioned to the edge system, a processing workload on the received images;
serializing, using the provisioned virtual call component, the visual data of the user; and
transmitting, using the provisioned virtual call component, the serialized visual data of the user, wherein the target system receives the serialized visual data of the user and renders the serialized visual data of the user as a visual representation of the user for the virtual call.
